(19) United States
(12) Patent Application Publication
(10) Pub. No.: US 2006/0118179 A1
(43) Pub. Date: Jun. 8, 2006

(54) Tap for gas cylinder with adiabatic compression prevention system, with variable pressure drop

(76) Inventors: Paul Kremer, Walferdange (LU); Claude Risse, Bertrange (FR)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 11/003,069

(22) Filed: Dec. 3, 2004

(51) Int. Cl. F16K 43/00

(52) U.S. Cl. 137/613

(57) ABSTRACT

A tap (10) for a gas cylinder has a non-sealing gate valve (44) positioned between an on/off valve (14) and a pressure reducer (18) of the tap. The gate valve (44) is normally in a position with a normal passage area. When the valve (14) is opened the gate valve (44) is rapidly moved by the pressurized gas towards a position with a limited passage area in order to reduce the shock wave applied to the pressure reducer (18). After the pressures on both sides of the gate valve (44) have been balanced, the gate valve returns to its position with a normal passage area.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

The present invention relates to a tap for a gas cylinder, comprising a tap body having a gas passage formed in the tap body, an on/off valve and an pressure reducer attached to the tap body, the valve being openable to allow the gas to flow out in venting mode through the said passage towards the pressure reducer, and a means for limiting the shock wave when the valve is opened, this means being positioned between the valve and the pressure reducer.

The velocities encountered in a tap for a gas cylinder at high pressure (more than 200 bar) are very high. For gases such as helium, the velocities can generally exceed the speed of sound. With such rates, some seats or plastics pads of pressure reducers cannot withstand the adiabatic shock and may burn in the presence of an oxidizing gas. It is therefore necessary to limit the pressure and reduce the gas velocity in order to absorb the shock wave when the main valve of the tap is opened to vent the gas. In the prior art, filters were provided between the main valve and the pressure reducer, but these filters have the disadvantage of interfering with the flow of gas when the cylinder is almost empty. Moreover, the filters may become clogged. They are consequently subject to shocks on each opening and may generate particles. With a high pressure, which may be of the order of 300 bar, in other words if the gas cylinder is full, known filters do not cause any problems and do not interfere with the flow. However, the filters cause a constant pressure drop, and at a low pressure, of less than 50 bar, perturbations commence and become worse at 10 bar. These known filters creating a constant pressure drop therefore alter with the gas expansion curve at low pressure.

### BRIEF SUMMARY OF THE INVENTION

The object of the invention is therefore to overcome this drawback and to provide a tap for a gas cylinder with a means for preventing the adiabatic shock without altering the gas expansion curve.

To achieve this object of the invention, the tap for a gas cylinder of the aforementioned type is characterized in that the means for limiting the shock wave comprises a movable gate valve positioned in the said gas passage, this gate valve being forced, when the valve is opened, by the effect of the shock wave from a first position in which there is a normal passage area to a second, non-sealing position with a limited passage area to reduce the shock wave, the said gate valve returning to its first position with a normal passage area after the gas pressure has been established on both sides of the gate valve.

The gate valve is normally in the open position, in other words the position with a normal passage area, and when the main tap is opened the gate valve is instantly pushed by the velocity and pressure of the gas towards its second, non-sealing position which limits the gas passage area in order to limit or absorb the shock wave or the adiabatic shock. In this second position, a small aperture having a passage area which is large enough to avoid interference with the flow at low pressure remains open, and after the balancing of the pressures the gate valve returns to its position with the larger passage area, as a result of which the system according to the invention can provide a variable pressure drop, unlike the constant pressure drop created by known filters. In the system according to the invention, the filter can be placed in the tail of the tap (inlet or conical connector) which has a larger area, thus avoiding shocks to the filter. The system according to the invention is very useful for applications using oxidizing gases, in other words oxygen, but also has advantages which should not be overlooked for applications using neutral or any other gases. The system is particularly suitable for oxygen applications at more than 200 bar. The invention enables user security to be enhanced by avoiding dangerous phenomena. The system according to the invention is particularly advantageous for oxygen therapy.

The system is useful for taps with incorporated piston-type pressure reducers having a gate valve in the low pressure area which is normally open, but it can be applied to other technologies. For example, the system can also be used with a pressure reducer having a gate valve in the high pressure area in a normally closed or open position. In another embodiment, the system according to the invention can be used in an assembly with a standard or conventional tap provided with an on/off valve linked by a duct to a pressure reducer. In this case, the adiabatic compression prevention system would be located in the duct immediately before the pressure reducer seat.

### BRIEF DESCRIPTION OF THE SEVERAL VIEWS OF THE DRAWINGS

The invention will now be explained in greater detail with reference to the attached drawings, in which:

FIG. 1 shows a tap for a gas cylinder with an incorporated pressure reducer and with the adiabatic compression prevention system according to the invention, the main on/off valve being in the closed position, and the gate valve of the adiabatic compression prevention system being in the first position with a normal passage area;

FIG. 2 is a view similar to that of FIG. 1 but with the main valve in the open position and the gate valve of the adiabatic compression prevention system in the second position which limits the gas passage area;

FIG. 3 shows the adiabatic compression prevention system (detail X) of FIG. 1, on an enlarged scale, with the gate valve in its position with a normal passage area which it occupies when the main valve of the tap is closed or if the main valve of the tap is opened after the gas pressure has been balanced on both sides of the gate valve;

FIG. 4 is a view similar to that of FIG. 3, but shows the detail Z of FIG. 2, on an enlarged scale, in other words with the gate valve in its position which limits the gas passage area; and

FIG. 5 shows the expansion curve for a tap according to the prior art and a tap with the system according to the invention.

Corresponding reference numerals will be used throughout the several figures of the drawings.

### DETAILED DESCRIPTION OF THE INVENTION

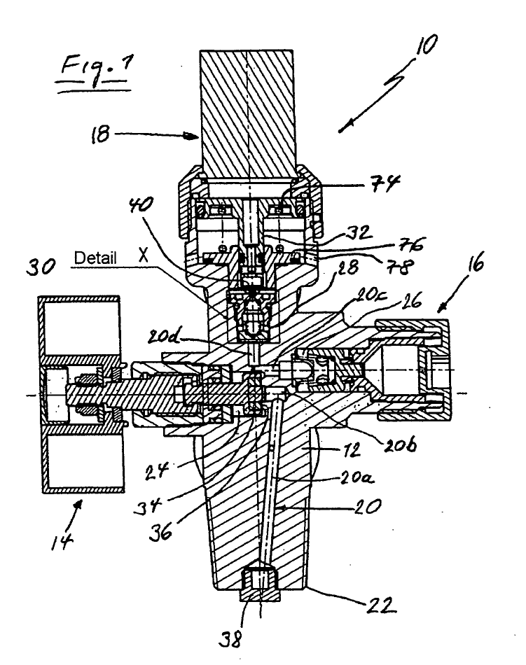

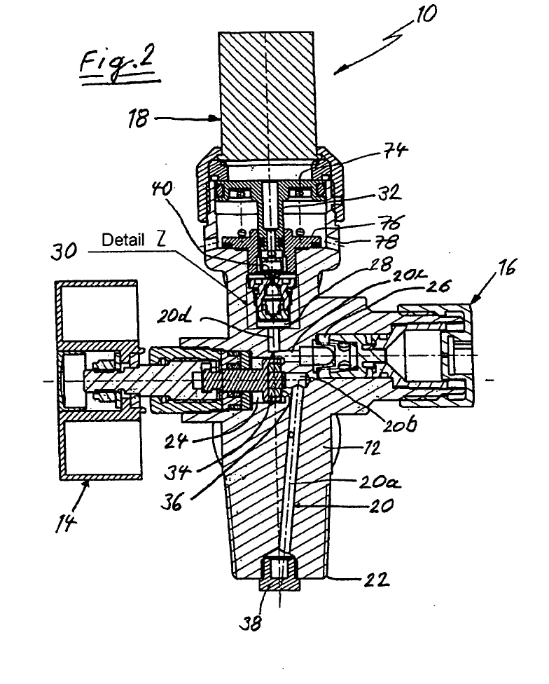

FIGS. 1 and 2 show a tap 10 for a gas cylinder according to the present invention, comprising a tap body 12, a main on/off valve 14, a filling valve 16 and an incorporated pressure reducer 18. A gas passage 20 extends from the lower end 22 of the tap body 12, for connection to the gas cylinder (not shown), to the incorporated pressure reducer 18. This gas passage 20 is commonly called the high-pressure section of the tap 10.

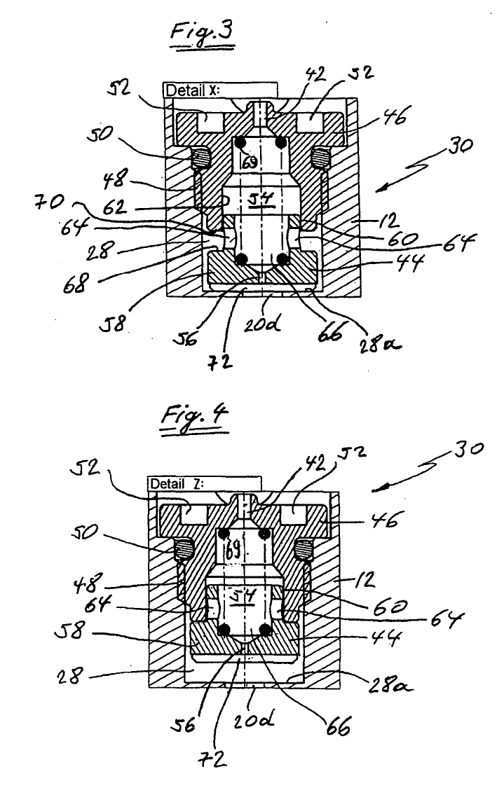

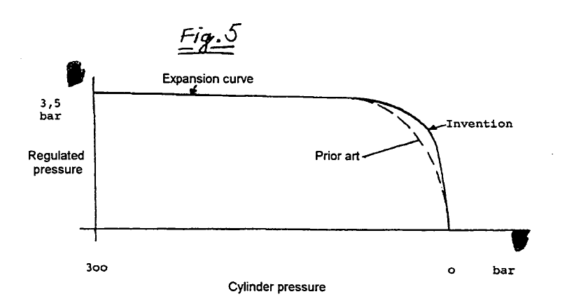

The gas passage 20 has a first part 20a extending obliquely upwards from the lower end of the tap body 12 and communicating with a first transverse part 20b which opens into a first transverse cavity 24 which, in turn, communicates with a second transverse part 20c of the gas passage 20 which, in turn, opens into a second transverse cavity 26. The gas passage also comprises a vertical part 20d which communicates with the second transverse part 20c and which has a vertical counter-bore 28, shown most clearly in FIGS. 3 and 4, and in which the adiabatic compression prevention system 30 according to the invention is placed (details X and Z of FIGS. 1 and 2). The adiabatic compression prevention system 30 is located in the bore 28 immediately below the piston 32 of the pressure reducer 18 which is connected to the upper end of the tap body 12 and which is known in the prior art.

The main valve 14 is also known in the prior art and will therefore not be described in detail here. It will simply be mentioned that this main valve 14 is provided with a sealing ring 34 engaging an annular seat 36 to form a seal at the bottom of the first transverse cavity 24 when the main valve 14 is closed. In the open position of the main valve 14, the sealing ring 34 is disengaged from the annular seat 36. The filling valve 16 is also known in the prior art and will therefore not be described in detail here. A filter 38 is located at the lower end of the first oblique part 20a of the gas passage 20. The piston 32 of the pressure reducer 18 is provided at its lower end with a pad 40 of plastics material which interacts with a fixed aperture 42 of the seat of the pressure reducer 46 (see FIGS. 3 and 4), to regulate the gas pressure.

The adiabatic compression prevention system 30, which will now be described with reference to FIGS. 3 and 4, comprises two parts 44 and 46, one being fitted into the other. The first part 44, in other words the lower part, is a gate valve 44 which is movable vertically in the vertical counter-bore 28, and the other, upper part 46, in other words the seat 46 of the pressure reducer 18, is received in a threaded housing 48 in the counter-bore 28.

A sealing ring 50 is positioned between the fixed seat 46 and the tap body 12. The fixed seat 46 is provided with a plurality of recesses 52 formed in its upper surface for the engagement of a tightening tool for the purpose of fixing the seat 46 in the counter-bore 28 of the tap body 12. A vertical gas passage 54 extends from one end to the other through the two parts 44 and 46 of the adiabatic compression prevention system 30. This vertical passage 54 comprises, at the upper end of the seat 46, the fixed aperture 42 interacting with the pad 40 of the piston 32 of the pressure reducer 18, for the purpose of regulating the gas pressure. The vertical passage 54 also comprises a central aperture 56 passing axially through the gate valve 44 and keeping the forward and downstream end of the gate valve 44 in constant communication. This aperture 56 forms the limited passage area. The movable gate valve 44 located at the upstream end of the fixed seat 46 is also provided with a vertical annular guide part 60 extending upwards from the lower head end 58 of the gate valve 44 and received slidably in a vertical bore 62 of the seat 46 of the pressure reducer 18.

One or more radial cut-outs or openings, for example holes 64, are formed in the vertical guide part 60 of the gate valve 44. These openings 64 extend radially through the wall of the guide part 60 to open in a bore 66 formed inside the movable gate valve 44. The central aperture 56 of the gate valve 44 is also in communication with the bore 66. The bore 66 is in constant communication with the bore 62 of the seat 46, and the bore 62 is in constant communication with the aperture 42.

In the first position of the gate valve 44 with a normal passage area, these radial openings 64 open into the space of the counter-bore 28 surrounding the gate valve 44 and form part of a passage by-passing the central aperture 56 and extending around the outside of the gate valve 44 in the counter-bore 28, to put the upstream end of the gate valve 44, in other words the part 20d of the gas passage 20, in communication with the downstream end of the gate valve 44, in other words the downstream end of the central aperture 56 of the gate valve 44 of the adiabatic compression prevention system 30.

A compression spring 69 is provided inside the two parts 44 and 46 and bears with its upper end on an upper surface of the bore 62 of the seat 46 of the pressure reducer 18 and with its lower end on a bottom surface of the bore 66 of the gate valve 44, so that the movable gate valve 44 is normally pushed downwards towards its first position of engagement with a bottom surface 28a of the counter-bore 28 of the tap body 12, around the part 20d of the gas passage 20 opening into the counter-bore 28.

The head part 58 of the gate valve 44 is provided at its upper end with a radial shoulder forming an annular bearing surface 68 which can contact an annular surface 70 forming a counter-bearing surface at the lower end of the seat 46 of the pressure reducer 18.

The external diameter of the head part 58 of the movable gate valve 44 is smaller than the diameter of the internal circumferential surface, which surrounds it, of the counter-bore 28, and the openings 64 are formed in the vertical guide part 60 between the radial shoulder 68 and the upper end of the guide part 60.

At the lower end of the head part 58 of the movable gate valve 44, on its radial surface opposite the seat 46 of the pressure reducer 18, there are provided appropriate means 72 such as spacers, ribs or grooves forming at least one radial passage, or any other appropriate means to ensure that the movable gate valve 44 cannot be engaged in a sealed way with the bottom surface 28a of the bore 28 of the tap body 12, in such a way that in the lower position (first position) of the gate valve 44, shown in FIG. 3, the part 20d of the gas passage 20 is in communication with the downstream end of the gate valve 44 (the downstream end of the central aperture 56) through the space of the counter-bore 28 surrounding the gate valve 44 and through the radial openings 64 (forming the normal passage area), and also through the central aperture 56 forming the limited passage area.

Conversely, in the upper position (second position) of the movable gate valve 44, in other words its position with a limited passage area as shown in FIG. 4, the movable gate valve 44 is moved upwards in such a way that its annular bearing surface 68 is in contact with the counter-bearing surface 70 of the fixed seat 46 of the pressure reducer 18, and the guide part 60 with its radial openings 64 is received completely inside the bore 62 of the fixed seat 46. The openings 64 are therefore blocked or closed, and the gas can no longer penetrate from the counter-bore 28 through these openings 64 into the adiabatic compression prevention system 30. Consequently, the gas at high pressure can pass through the adiabatic compression prevention system 30 only via the limited small central aperture 56, and the adiabatic shock applied to the pad 40 of the movable piston 32 of the pressure reducer 10 is limited.

It should also be noted that the gas escaping through the aperture 42 of the fixed seat 46 flows upwards in an annular passage surrounding the lower end of the piston 32 of the pressure reducer 18, then passes to the inside of the piston 32 and leaves the piston at its upper end.

If the pressure on the upper end of the piston 32 becomes too great, the piston 32 is forced downwards against the force of the helical spring 74 (FIGS. 1 and 2), thus reducing the space between the aperture 42 of the fixed seat 46 and the pad 40 of the piston 32. A safety valve 76 surrounds the piston 32 of the pressure reducer 18. If the pressure below this safety valve 76 becomes too high, the safety valve 76 is moved vertically upwards against the force of the spring and the gas can escape through the radial holes 78.

The adiabatic compression prevention system 30 is normally in the position of FIG. 3 when the main tap 14 is closed. In this case, the movable gate valve 44 is pushed downwards by the spring 69 and engages with the bottom surface 28a of the counter-bore 28 of the body 12 of the tap 10 around the part 20d of the gas passage 20.

When the tap 14 is opened, the gas under high pressure flows in at high velocity through the part 20d of the passage 20 and forces the movable gate valve 44 upwards against the action of the spring 69 thus moving the gate valve 44 towards its upper position in which the openings 64 are positioned inside the fixed seat 46 of the pressure reducer 18 and are therefore no longer in communication with the space of the counter-bore 28 surrounding the movable gate valve 44. The gas under pressure can pass through the adiabatic compression prevention system 30 only via the aperture 56 with minimal passage area formed in the gate valve 44, which is in constant communication with the upstream and downstream ends of the gate valve 44.

When the gas pressure has been established on both sides of the movable gate valve 44, the spring 69 can again push the movable gate valve 44 downwards into contact with the bottom surface 28a of the counter-bore 28 (the position of FIG. 3). In this position, a normal, enlarged passage area is provided for the gas under pressure, which can now by-pass the central aperture 56 and pass from the part 20d of the gas passage 20 into the radial passage 72, flowing in an outward radial direction into this passage, and can then flow upwards in the counter-bore 28 around the lower head part 58 of the gate valve 44 and finally inwards through the radial openings 64 to enter the vertical passage 54 and finally escape through the aperture 42 located in the proximity of the pad 40 of the piston 32 of the pressure reducer 18.

Thus, when the main tap 14 is opened, the adiabatic compression prevention system 30 limits the flow and velocity of the gas to protect the pressure reducer, by providing a limited passage area for the gas under pressure, and, when the gas pressure has been established on both sides of the gate valve, the gate valve is moved to an open position, providing a normal passage area which is larger (by a factor of two to five) for the gas under pressure. By comparison with the filters (having a particle size or porosity of approximately 20 um) known in the prior art, the adiabatic compression prevention system according to the present invention provides a variable passage area for the gas under pressure, in other words a limited passage area on the opening of the main valve and a normal, larger passage area after the gas pressure has been established on both sides of the gate valve. Thus the system according to the invention is a variable pressure drop system. It should be noted that the resistance to the passage of the gas under pressure through the central aperture 56 is lower than the resistance to the passage of the gas through the known filters of the prior art, and therefore the system according to the present invention affects the expansion curve less than the known filters, as shown in FIG. 5, but provides the same protection against adiabatic shock as the known filters. As shown in FIG. 5, in the system according to the invention the desired regulated pressure P2 can be maintained for longer when the pressure P1 in the cylinder decreases and the cylinder is almost empty. In other words, the quality of the flow curves will be better than with the conventional system (or with a filter).

The invention is not limited to the particular embodiments shown in the drawings, and various modifications can be made without departing from the scope of the attached claims. For example, the circular cut-outs or openings 64 could be replaced with elongate cut-outs extending to the upper end of the vertical guide part 60. Also, instead of the openings 64 formed in the gate valve 44, it would be possible to provide cut-outs formed by grooves in the seat 46 of the pressure reducer 18 which would be blocked by the vertical guide part 60 of the gate valve when it was received in the fixed seat 46. Additionally, instead of being guided in the fixed seat 46, the gate valve 44 could have vertical ribs on its outer circumference, spaced apart in the circumferential direction and guided on the inner circumferential surface of the counter-bore 28. In this case, the normal passage by-passing the central aperture 56 of the gate valve 44 would be made to communicate with the downstream end of the central aperture 56 of the gate valve 44 via an annular passage opened between the bearing surface 68 and the counter-bearing surface 70 when the gate valve 44 is pushed downwards by the spring 68 towards its first position with a normal passage area. Furthermore, instead of forming one or more radial passages 72 in the upstream surface of the gate valve 44, this surface can be smooth and passages or grooves can be formed in the bottom surface 28a of the counter-bore 28. Other modifications are possible and can be provided by persons skilled in the art if necessary.

1. A tap for a gas cylinder, comprising a tap body having a gas passage formed in the tap body, an on/off valve and a pressure reducer attached to the tap body, the valve being openable to allow the gas to flow out in a venting mode through the said passage towards the pressure reducer, and a means for limiting the shock wave when the valve is opened; the means being positioned between the valve and the pressure reducer and comprising a movable gate valve positioned in said gas passage, the gate valve being forced by the effect of a shock wave when the on/off valve is opened, from a first position with a normal passage area towards a second, non-sealing position with a limited passage area, in order to reduce the shock wave, the said gate valve returning to its first position with a normal passage area after the gas pressure has been established on both sides of the gate valve.

2. The tap according to claim 1 wherein the gate valve is located upstream of a fixed seat of a pressure reducer, is provided with an aperture facing the regulating element of the pressure reducer, and is pushed towards its first position by a spring positioned between the gate valve and the seat of the pressure reducer.

3. The tap according to claim 2 wherein the gate valve is provided with a limited aperture which passes through it and places the upstream and downstream ends of the gate valve in constant communication; the aperture forming the limited passage area, and in that, in the first position with a normal passage area, the upstream and downstream ends of the gate valve are also in communication through a passage by-passing said aperture and extending around the gate valve, this passage by-passing the aperture being closed in the in the second position of the gate valve.

4. The tap according to claim 3 wherein one or more cut-outs are formed in the gate valve or in the seat of the pressure reducer; the cut-outs being open in the first position of the gate valve to place said passage by-passing the aperture in communication with the downstream end of the aperture of the gate valve, and being blocked in the second position of the gate valve.

5. The tap according to claim 4 wherein the one or more cut-outs are formed in an annular guide part of the gate valve which is received slidably inside the seat of the pressure reducer, the one or more cut-outs being blocked by the seat of the pressure reducer in the second position of the gate valve.

6. The tap according to claim 5 wherein the gate valve has a bearing surface which contacts the seat of the pressure reducer in the second position of the gate valve.

7. The tap according to claim 3 wherein the radial surface of the gate valve opposite the seat of the pressure reducer is provided with spacing means in order to keep the passage by-passing the gate valve in communication with the gas passage upstream of the gate valve in the first position of the gate valve.

8. An assembly comprising a tap for a gas cylinder and a pressure reducer with a duct provided between the tap and the pressure reducer, wherein the tap includes a means for limiting the shock wave when the tap is opened; said means being positioned in said duct before the pressure reducer; said means comprising a movable gate valve; the gate valve being forced by the effect of the shock wave when the tap is opened, from a first position having a normal passage area to a second, non-sealing position having a limited passage area, in order to reduce the shock wave, said gate valve returning to its first position with a normal passage area after the gas pressure has been established on both sides of the gate valve.

9. The assembly according to claim 8 wherein the gate valve is located upstream of a fixed pressure reducer seat and is provided with an aperture facing the regulating element of the pressure reducer; the gate valve being pushed towards its first position by a spring positioned between the gate valve and the seat of the pressure reducer.

10. The assembly according to claim 9 wherein the gate valve is provided with a limited aperture which passes through it and places the upstream and downstream ends of the gate valve in constant communication, the limited aperture forming the limited passage area, and in that, in the first position with a normal passage area, the upstream and downstream ends of the gate valve are also in communication through a passage by-passing said limited aperture and extending around the gate valve, this passage by-passing the limited aperture being closed in the second position of the gate valve.

11. The assembly according to claim 10 wherein one or more openings are formed in the gate valve or in the seat of the pressure reducer, these openings being open in the first position of the gate valve to place said passage by-passing the aperture in communication with the downstream end of the aperture of the gate valve, and being blocked in the second position of the gate valve.

12. The assembly according to claim 11 wherein the one or more openings are formed in an annular guide part of the gate valve which is received slidably inside the seat of the pressure reducer; the one or more openings being blocked by the seat of the pressure reducer in the second position of the gate valve.

13. The assembly according to claim 12 wherein the gate valve has a bearing surface which contacts the seat of the pressure reducer in the second position of the gate valve.

14. The assembly according to claim 10 wherein the radial surface of the gate valve opposite the seat of the pressure reducer is provided with spacing means in order to keep the passage by-passing the gate valve in communication with the gas passage upstream of the gate valve in the first position of the gate valve.
